(19) United States
(12) Patent Application Publication
(10) Pub. No.: US 2009/0300847 A1
(43) Pub. Date: Dec. 10, 2009

(54) Automobile windshield installation device

(76) Inventor: Yi-Chang Chan, San Chung City (TW)

Correspondence Address: PRO-TECHTOR INTERNATIONAL SERVICES, 20775 NORADA CT., SARATOGA, CA, 95070, US

(21) Appl. No.: 12/157,004

(22) Filed: Jun. 5, 2008

(51) Int. Cl. B25F 1/00

(52) U.S. Cl. 7/100

(57) ABSTRACT

The present invention is an automobile windshield installation device, two of which can be operated by a single operator to install or dismantle a windshield by two sucking discs in a DIY way. A single installation device includes a main rod, two extension tubes, an extension rod, three positioning seats, a branch tube and a grip device. A lower end of the main rod can be provided with a stand to support the installation device, the extension tubes and the extension rod can ascend or descend depending on practical needs, and the sucking disc at a side of the grip device can attach the windshield.

### BACKGROUND OF THE INVENTION

1. Field of the Invention

The present invention relates to an automobile windshield installation device, and more particularly to an installation device, two of which are operated by an operator to easily install a windshield on an automobile.

2. Description of the Prior Art

When an automobile windshield is to be installed or dismantled in an ordinary auto maker, the front and rear windshields should be installed or dismantled by at least two workers, as the windshields are large and heavy. Referring to FIG. 8, left and right ends on a conventional windshield 100 are sucked respectively with a grip device 200, and upper and lower ends of the straight-rod grip device 200 are provided respectively with a sucking disc 201, enabling the grip device 200 to stably attach the windshield 100, so as to facilitate the workers to exchange or install the windshield. As the grip device 200 is not able to provide for a single worker to install the windshield alone, a lot of labor works and hours will be spent to install the windshield.

### SUMMARY OF THE INVENTION

The primary object of the present invention is to provide an automobile windshield installation device, two of which can be operated by an operator to easily install a windshield on an automobile in a DIY (Do-It-Yourself) way.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of the present invention.

FIG. 2 shows a schematic view of the present invention that is extended.

FIG. 3 shows a plan cutaway view of a hook of the present invention (locked).

FIG. 4 shows a plan cutaway view of a hook of the present invention (released).

FIG. 5 shows a partial structural view of the present invention.

FIG. 6 shows a partial exploded view of the present invention.

FIG. 7 shows another partial structural view of the present invention.

FIG. 8 shows a schematic view of appearance of a conventional product.

### DETAILED DESCRIPTION OF THE PREFERRED EMBODIMENTS

In actual installation of a windshield, an operator will operate two installation devices to install the large windshield on an auto body.

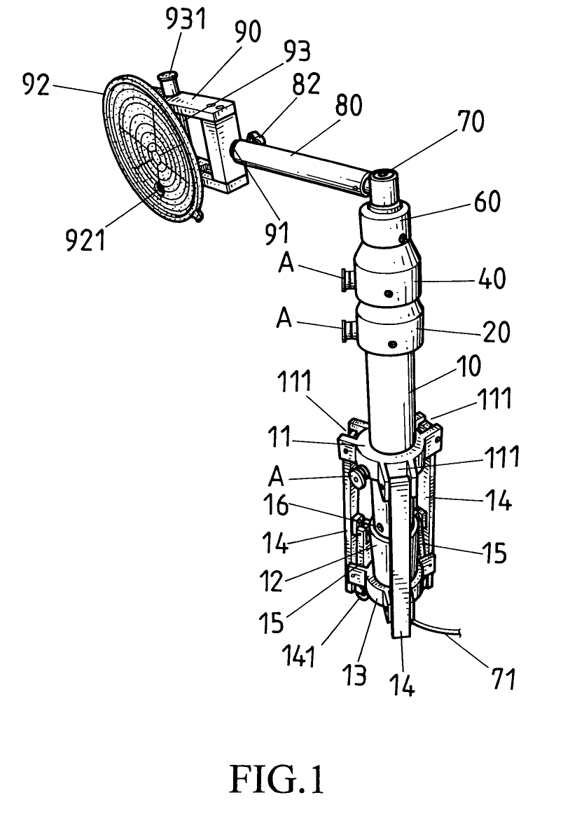

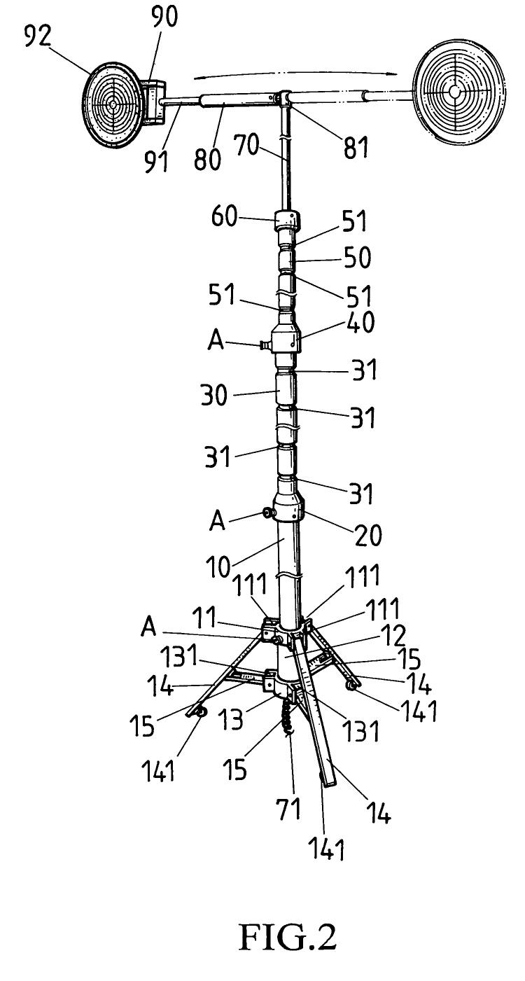

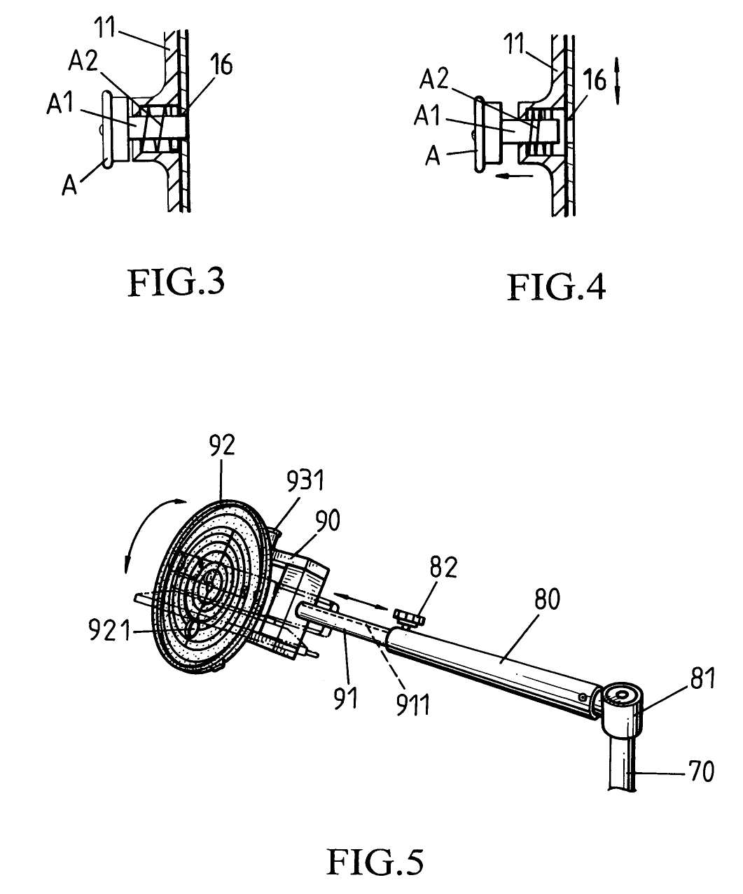

Referring to FIG. 1 and FIG. 2, a single installation device of the present invention comprises a hollow main rod 10, which is sheathed with a movable collar 11, and a bottom of which is connected to a fixing ring 13 by a sleeve 12, with three grooves 111, 131 being provided respectively on corresponding positions of the movable collar 11 and the fixing ring 13, a stand 14 and a strut 15 being axially coupled inside the grooves 111, 131 respectively, and an exterior side of the strut 15 being pivoted with an interior side of the stand 14. Referring to FIG. 2, when the movable collar 11 descends, the three stands 14 and three struts 15 are extended to put up the device. Moreover, the movable collar 11 is installed with a hook A. Referring to FIG. 3 and FIG. 4, a hook rod A1 at an end of the hook A is transfixed into a spring A2 and then penetrates into the movable collar 11. As upper and lower ends of the main rod 10 are provided respectively with a hook hole 16 for locking the hook rod A1 (as shown in FIG. 3), when the stands 14 and the struts 15 are collected or extended, the hooks A can be pulled and the springs A2 are compressed, enabling the hook rods A1 to escape from the hook holes 16 (as shown in FIG. 4), so as to facilitate adjusting a position of the movable collar 11. On the other hand, a bottom of each of three stands 14 is provided with a roller 141 to facilitate pushing the device.

The present invention also includes a lower positioning seat 20, which is in a hollow shape and is fastened at a top end of the main rod 10, and a side of which is provided with the hook A (as shown in FIG. 3 and FIG. 4); a first extension tube 30, which is extended into the hollow main rod 10, and a wall of which is provided with a plurality of transversal locking slots 31 for fastening the hook rod A1 of the hook A at the lower positioning seat 20, with height of the extension tube 30 being changed when an operator pulling the hook A to lock it into the proper locking slot 31; a middle positioning seat 40, which is in a hollow shape and is fastened at a top end of the first extension tube 30, and a side of which is provided with another hook A (as shown in FIG. 3 and FIG. 4); a second extension tube 50, which is extended into the first extension tube 30, and a wall of which is provided with a plurality of transversal locking slots 51 for fastening the hook rod A1 of the hook A at the middle positioning seat 40, with height of the extension tube 50 being changed when the operator pulling the hook A to lock it into the proper locking slot 51; an upper positioning seat 60, which is in a hollow shape and is fastened at a top end of the second extension tube 50; and an extension rod 70, which is extended into the second extension tube 50, and a bottom end of which is connected with an electric wire 71. The electric wire 71 is transfixed into the second and first extension tubes 50, 30 as well as the main rod 10 to be exposed out of a bottom of the device, such that the electric wire 71 can be connected with a plug to be inserted to an automobile cigarette lighter for energizing. In addition, ascending and descending of the extension rod 70 is adjusted by a remote controller.

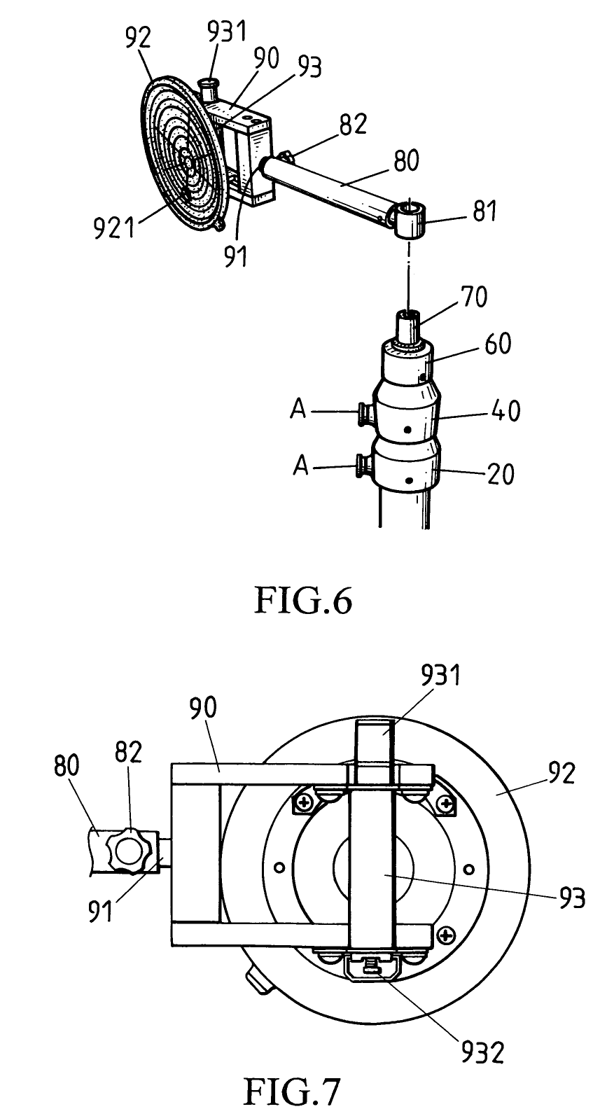

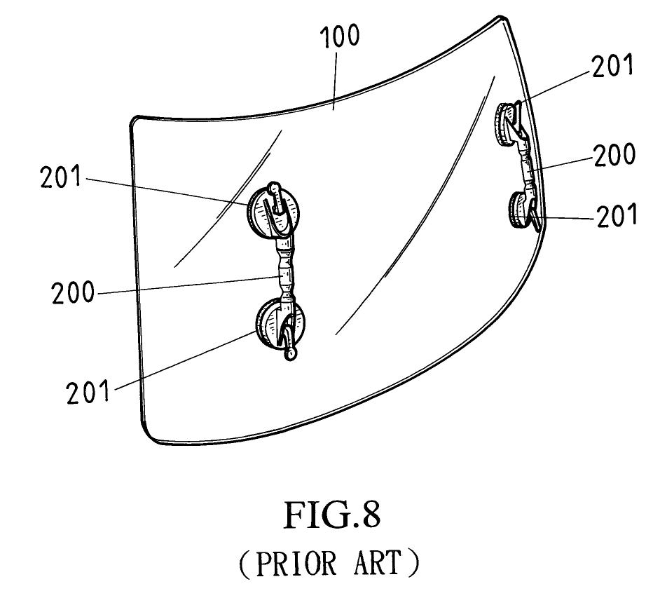

Referring to FIGS. 5 to 7, the present invention further includes a branch tube 80, an end of which is axially coupled with a collar 81 that is sheathed on a top end of the extension rod 70 and rotates by 360° along with the extension rod 70 (as shown in FIG. 1), and a flange of which is provided with a bolt 82 that is transfixed into a tube wall; and a grip device 90, an end of which is provided with a strut 91 that is extended into the branch tube 80, with a groove 911 on the strut 91 providing for the bolt 82 of the branch tube 80 to rotate into for positioning, and the other end of which is fixed with a sucking disc 92, with the sucking disc 92 being adjusted to displace up and down by the branch tube 80 (as shown in FIG. 5), a surface of the disc-shape sucking disc 92 being provided with an air hole 921, and a back side of the sucking disc 92 being provided with an air piston 93 connected with the air hole 921. An interior of the air piston 93 is provided with a piston rod 931 and a spring (not shown in the drawings), and by pressing the piston rod 931 in the air piston 93 to pump air continuously, air inside the sucking disc 92 can be discharged at the air hole 921 to form vacuum, so as to attach the windshield. The other end of the air piston 93 is provided with a vent valve 932, and by pressing the vent valve 932, ambient air can be guided into the sucking disc 92, facilitating the sucking disc 92 to release the attached windshield.

The operator uses both hands to hold the air pistons 93 on the grid devices 90 of two installation devices respectively, and at a same time, pushes the two installation devices to move forward, so as to install the windshield on the automobile.

As the above description shows, the present invention provides two installation devices that are operated by the operator to easily install the automobile windshield in a DIY way.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automobile windshield installation device, two of which are operated by an operator to install a windshield on an automobile, comprising:
a hollow main rod, which is sheathed with a movable collar and a bottom of which is connected with a fixing ring by a sleeve, with three grooves being provided respectively on corresponding positions of the movable collar and the fixing ring, an interior of each groove being coupled axially with a stand and a strut respectively, and an exterior side of the strut being pivoted with an interior of the stand, such that when the movable collar descends, the three stands and three struts are extended, with the movable collar being provided with a hook, a hood rod at an end of the hook transfixing into a spring and then penetrating into the movable collar, upper and lower ends of the main rod being provided respectively with a hook hole for locking the hook rod;
a lower positioning seat, which is in a hollow shape and is fastened at a top end of the main rod, and a side of which is provided with a hook, with a hook rod at an end of the hook transfixing into a spring;
a first extension tube, which is extended into the hollow main rod, a wall of which is provided with a plurality of locking slots for locking the hook rod of the hook at the lower positioning seat;
a middle positioning seat, which is in a hollow shape and is fastened at a top end of the first extension tube, and a side of which is provided with a hook, with a hook rod at an end of the hook transfixing into a spring;
a second extension tube, which is extended into the first extension tube, and a wall of which is provided with a plurality of locking slots for locking the hook rod of the hook at the middle positioning seat;
an upper positioning seat, which is in a hollow shape is fastened at a top end of the second extension tube;
an extension rod, which is extended into the second extension tube, and a bottom end of which is connected with an electric wire that is inserted to an automobile cigarette lighter, with ascending and descending of the extension rod being adjusted by a remote controller;
a branch tube, an end of which is axially coupled with a collar, with the collar being sheathed on a top end of the extension rod to rotate with the extension rod, and a flange of the branch tube being provided with a bolt that is transfixed into a tube wall; and
a grip device, a strut at an end of which is extended into the branch tube, with a groove on the strut providing for the bolt of the branch tube to rotate in for positioning, and the other end of the grip device being fastened with a sucking disc to attach a windshield.

2. The automobile windshield installation device according to claim 1, wherein a bottom of each of the three stands of the main rod is provided respectively with a roller.

3. The automobile windshield installation device according to claim 1, wherein a disc surface of the sucking disc on the grip device is provided with an air hole, a back side of the sucking disc is provided with an air piston which is connected with the air hole, and an interior of the air piston is provided with a piston rod; by pressing the piston rod to pump air in the air piston, the windshield being attached; the other end of the air piston being provided with a vent valve, and by pressing the vent valve to guide ambient air into the sucking disc, the windshield being released.
